(19) United States
(12) Patent Application Publication
(10) Pub. No.: US 2016/0078002 A1
(43) Pub. Date: Mar. 17, 2016

(54) REPRESENTING NUMERICAL DATA IN A MOBILE DEVICE

(71) Applicant: HEWLETT-PACKARD DEVELOPMENT COMPANY L.P., Houston, TX (US)

(72) Inventors: Joshua Hailpern, Sunnyvale, CA (US); Bernardo Huberman, Palo Alto, CA (US)

(21) Appl. No.: 14/786,362

(22) PCT Filed: Aug. 13, 2013
(86) PCT No.: PCT/US2013/054696

§ 371 Date: Oct. 22, 2015

(51) Int. Cl. G06F 17/21; G06F 17/22

(52) U.S. Cl. CPC G06F 17/211; G06F 17/2205

(57) ABSTRACT

A platform for representing numerical data in a mobile device is disclosed. The platform receives numerical data from at least one party, the numerical data arranged into multiple categories. Categories are selected from the multiple categories for display in the mobile device. Data attributes in each selected category are associated with at least one infographic. Display views of the data attributes in each selected category are created using the at least one infograpic, the display views expandable for each selected category.

### BACKGROUND

Mobile devices have become increasingly popular. It is estimated that the majority of Internet traffic will be conducted over mobile devices in the near future. Users rely on their mobile devices to visit web sites, run applications, play games, send email, communicate via phone and/or text messages, engage in social networks, and so on. The mobile devices may have a range of different form factors (e.g., screen sizes, styles, etc.) and include, for example, smartphones, gaming devices, personal digital assistants, tablets, and laptops, among others.

The variety of different form factors has challenged developers to adapt their applications to different users' needs. An application or web site that is viewed on a laptop with a large screen size may not be able to display or convey the same information in a smaller smartphone. Users may find it cumbersome to interact with a small display. As a result, mobile devices with small screen sizes have not yet been fully deployed in enterprises and other environments where users deal with large amounts of information on a daily basis.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 illustrates a schematic diagram of an environment where a platform for representing numerical data in a mobile device is used in accordance with various examples;

FIG. 2 illustrates examples of physical and logical components for implementing a platform for representing numerical data in a mobile device;

FIG. 3 is a flowchart of example operations performed by the platform of FIG. 2 for representing numerical data in a mobile device;

FIGS. 4-18 are example display views generated by the User Interface Module of the platform shown in FIG. 2;

FIG. 19 is an example customized user interface that may be used to enter numerical data for display in a mobile device by the platform of FIGS. 2; and

FIG. 20 is an example configuration screen generated by the Configuration Module of the platform shown in FIG. 2.

### DETAILED DESCRIPTION

A platform for representing numerical data in mobile devices is disclosed. The platform enables users to efficiently access a large amount of numerical data in a small screen size in a format that is not only visually appealing but also informative. The numerical data may include, for example, financial or organizational data typically viewed in spreadsheets, documents, or other forms. The numerical data may be arranged into multiple categories and have multiple data attributes. As generally described herein, a data category refers to a class of data and a data attribute refers to a type of data.

For example, a data category may include time periods quarters in an organization's fiscal year), geographical regions (e.g., Americas, EMEA, Asia-Pacific, etc.), business units, product divisions and other dimensions of interest. The data categories may have multiple data attributes, such as a budget value, a projected budget value, capital expenditures, personnel costs, manufacturing costs, and so on. As described in more detail herein below, the platform facilitates the display of selected information (i.e., data attributes in selected categories) with associated infographics, which are graphic visual representations (e.g., icons) of information intended to present the information to users quickly and clearly.

In various examples, the platform may include a data retrieval module to receive numerical data arranged into multiple categories from at least one party, a configuration module to select data categories and a plurality of infographics for selected data categories, and a user interface module to create display views of the numerical data in the selected data categories using the plurality of infographics, where the data views are expandable for each selected data category. The platform may also include a data processing module to process the numerical data and extract values for a plurality of data attributes in the selected categories, and a data publishing module to publish the display views to a web client accessible by a login user of a mobile device.

It is appreciated that, in the following description, numerous specific details are set forth to provide a thorough understanding of the examples. However, it is appreciated that the examples may be practiced without limitation to these specific details. In other instances, well known methods and structures may not be described in detail to avoid unnecessarily obscuring the description of the examples. Also, the examples may be used in combination with each other.

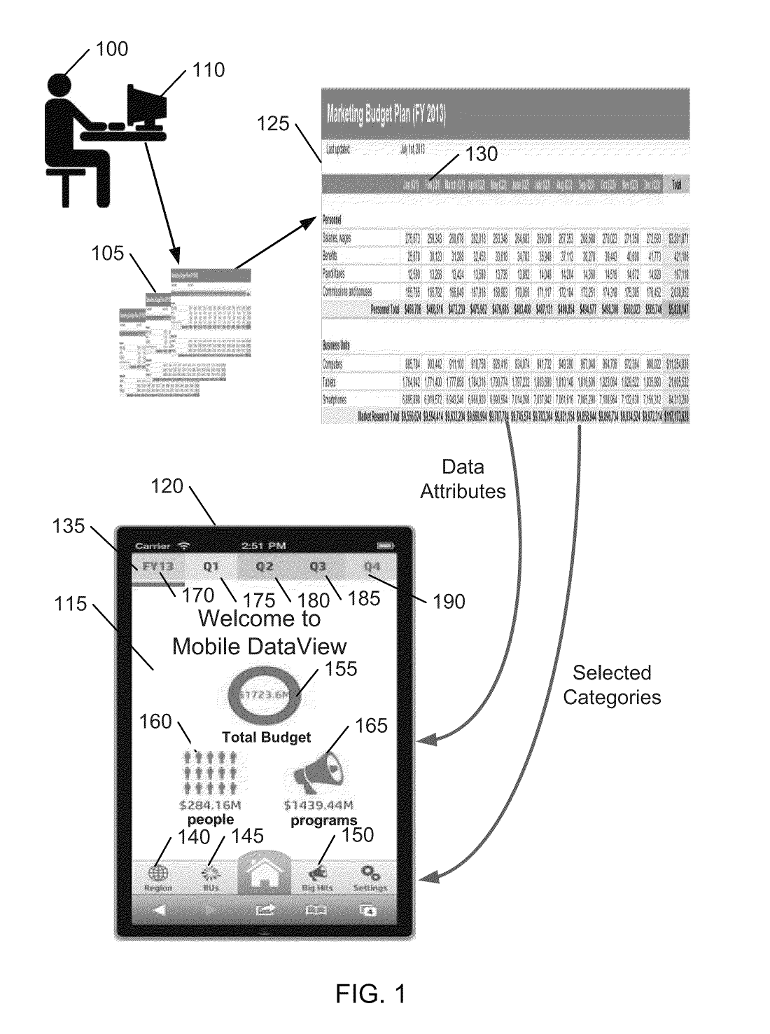

Referring now to FIG. 1, a schematic diagram of an environment where the platform is used in accordance with various examples is described. User 100 has access to a large amount of numerical data, such as numerical data embodied in a variety of spreadsheets or documents 105. The user 100 may be, for example, an employee of an organization that views and analyzes numerical (e.g., financial, legal, marketing, etc.) data to make decisions. In a typical scenario, the user 100 may view the data in a large display connected to a computing device 110 (e.g., a desktop, laptop, etc.). The platform as described in more detail herein below enables the user 100 to also view and analyze numerical data in mobile devices having small screen sizes (e.g., tables, smartphones, small laptops, etc.), such as mobile device 120.

The platform generates various display views of the numerical data in selected data categories and using a plurality of infographics to represent various data attributes in the selected data categories. An example display view 115 is shown displayed in the screen of mobile device 120 for numerical data in spreadsheet 125. The spreadsheet 125 has numerical data arranged in multiple categories, such as data arranged by time 130. The numerical data may represent, for example, financial data for marketing campaigns of a given organization, financial data for a research and development division, financial data for a legal organization, and so on.

As described in more detail below, data categories may be selected to be represented in a display view for a mobile device, such as categories of time 135, geographical region 140, business units 145 and big hits (e.g., marketing campaigns) 150. Data attributes in the selected categories may be viewed in the display view 115 with associated infographics, such as the data attribute of a total budget viewed with infographic 155, the data attribute of the budget spent in people in the organization with infographic 160, and the data attribute of the budget spent per marketing program in the organization with infographic 165. Infographics 155-165 enable a user of mobile device 120 to quickly view relevant information from spreadsheet 125 in a small screen size.

In the example shown in FIG. 1, display view 115 displays data attributes for the time period of “FY13” 170, but it can be easily changed by the user interacting with mobile device 120. As described in more detail below, the display view 115 can be expandable for multiple categories. For example, the user can click (or touch in the case of a touch screen) on different time periods 175-190 to see the data attributes for the different time periods, or click on the infographics associated with categories 140-150 to see data for different regions, business units, or big hits marketing campaigns. As the user clicks on the infographics associated with the categories 140-150, the same, different, or additional data attributes can be displayed in the mobile device 120. The data attributes displayed may be computed automatically by the data processing module and aggregated for the selected category before display. For example, a budget value may be computed for a given geographical region by computing the sum of the budget across different locations within the region. The budget value for the geographical region may also already be specified in the spreadsheet 125, in which case no computation is needed. Either way, the user can quickly have a visual and efficient representation of the numerical data in spreadsheet 125, without having to open the entire spreadsheet 125. The different display views can also he shown in different colors as desired. It is noted that data categories 135-150 and infographics 155-165 are shown for purposes of illustration only. Different and/or additional categories, infographics, numerical data, and data attributes can be selected for representation and display in a mobile device.

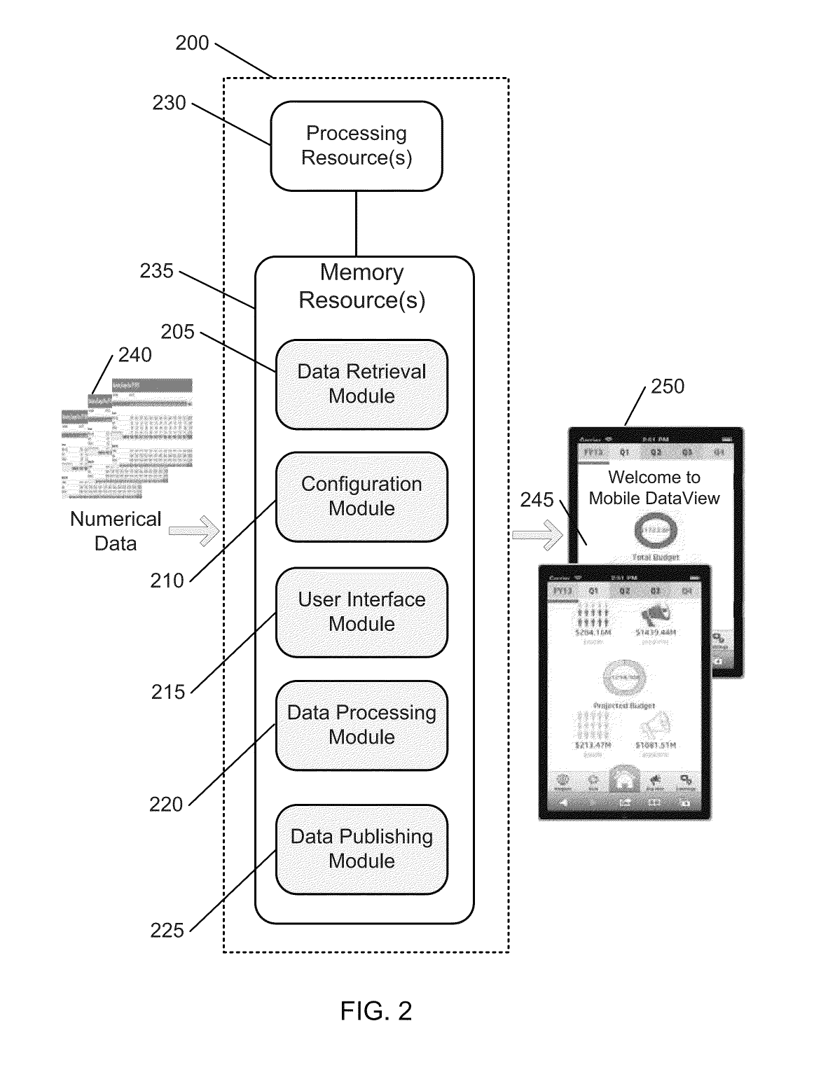

Attention is now directed to FIG. 2, which shows examples of physical and logical components for implementing the platform. Platform 200 has various modules, including, but not limited to a Data Retrieval Module 205, a Configuration Module 210, a User Interface Module 215, a Data Processing Module 220, and a Data Publishing Module 225. In an example implementation, modules 205-225 may be implemented as instructions executable by one or more processing resource(s) 230 and stored on one or more memory resource(s) 235.

A memory resource 235, as generally described herein, can include any number of memory components capable of storing instructions that can be executed by processing resource(s) 230, such as a non-transitory computer readable medium. It is appreciated that memory resource(s) 235 may be integrated in a single device or distributed across multiple devices. Further, memory resource(s) 235 may be fully or partially integrated in the same device (e.g., a server device) as processing resource(s) 230 or it may be separate from but accessible to processing resource(s) 230. Accordingly, platform 200 may be implemented on a server device or on a collection of server devices, such as in one or more web servers. Display views 245 generated by platform 200 of numerical data 240 may be viewed by a user of a mobile device 250 via a web client or application deployed in the mobile device by platform 200.

Data Retrieval Module 205 receives numerical data arranged into multiple categories from at least one party. The data may be received by having a user enter the numerical data in a customized user interface or send the numerical data to the Data Retrieval Module 205. Alternatively, the data can also be received via a live stream of data captured by the Data Retrieval Module 205. Configuration Module 210 can be used to select data categories from the multiple categories for display as well as a plurality of infographics for the data categories. In various examples, the Configuration Module 210 may include a user interface to enable a user to select the data categories and infographics for display. The user interface may contain categories and infographics that are customized for one or more organizations and/or specified by the one or more organizations in advance through discussions and planning between users of numerical data 240 and developers of platform 200.

User interface Module 215 creates display views of the numerical data 240 in the selected categories using the plurality of infographics. The display views are designed to be visually appealing and easy to understand while providing valuable and relevant numerical data to users. A user of mobile device 250 can interact with the display views to view infographics representing data attributes and data categories for the numerical data 240. In various examples, the display views are expandable for each selected category upon user interaction with the display views, such as, for example, by touching or clicking on the display screen of the mobile device 250. The display views may also be expandable for each selected category across time, geographical regions, or other dimensions of interest. Each display view may be shown in a different color to indicate to the user a change in the view being displayed. For example, one color may be used for a display view showing data attributes and categories for a given financial quarter, and another color may be used for another quarter. Further, the display views may be accessible at the mobile device 250 only by registered users via a login screen.

Data Processing Module 220 processes the numerical data received, by the Data Retrieval Module 205 and extracts values for a plurality of data attributes to be displayed in the display views generated by the User Interface Module 215. The processing may include computation and, aggregation of values for data attributes (e.g., computation of a total or projected budget).

Data Publishing Module 225 publishes the display views generated by the User Interface Module 215 to a web client or application accessible at the mobile device 250. It is noted that the display views may be updated when the numerical data is itself updated. In this case, a user may update the numerical data and indicate to the Data Processing Module 220 and the Data Publishing Module 225 that new data is ready for processing and publishing. The Data Publishing Module 225 can also be used to communicate with the User Interface Module 215 to handle requests for display views from users of the mobile device 250.

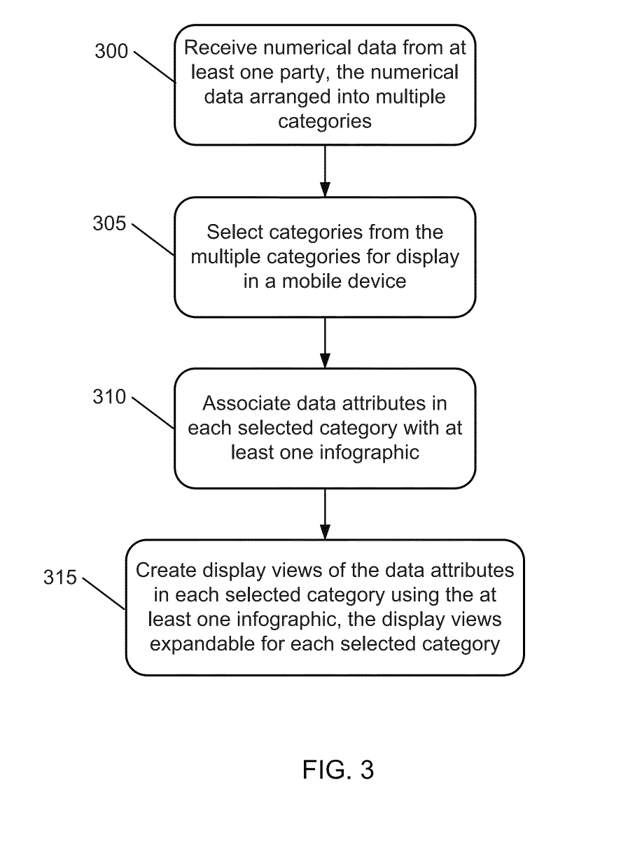

Referring now to FIG. 3, a flowchart of example operations of the platform of FIG. 2 for representing numerical data in mobile devices is described. First, numerical data is received from at least one party, the numerical data arranged into multiple data categories (300). Next, categories are selected from the multiple categories for display in a mobile device (305). Data attributes in each selected category are associated with at least one infographic (310). Lastly, display views of the data attributes in each selected category are created using the at least one infographic (315). The display views are expandable for each selected category through user interaction with the mobile device.

As described, above in FIG. 2, the Data Retrieval Module 205, the Data Configuration Module 210, and the User Interface Module 215 implement steps 300-315. The Data Processing Module 220 and the Data Publishing Module 225 are further used to process the data and publish the data to the mobile device.

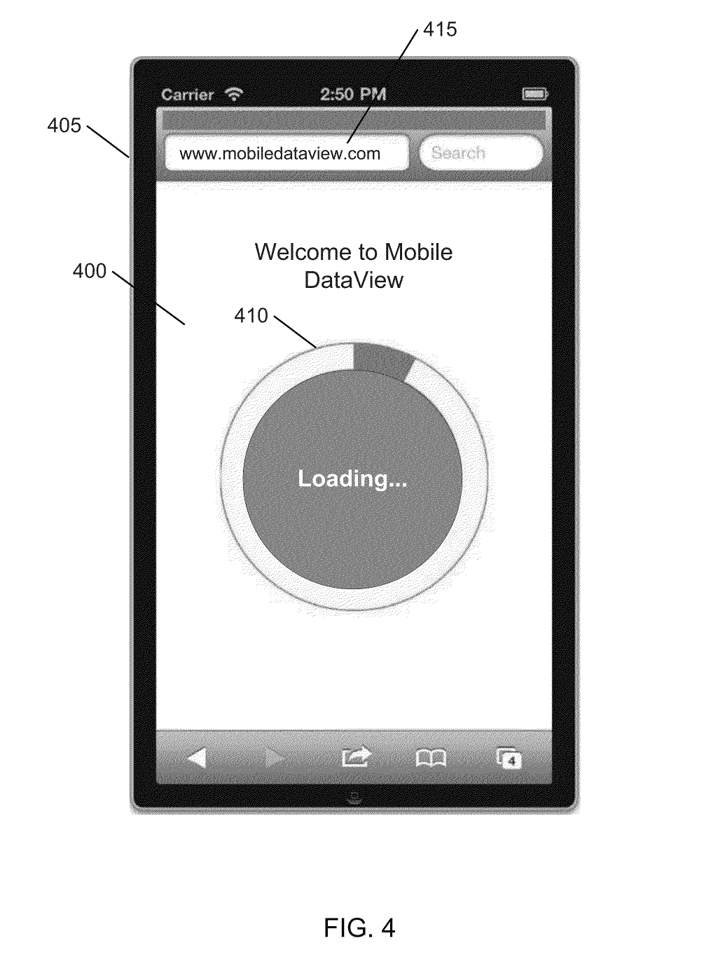

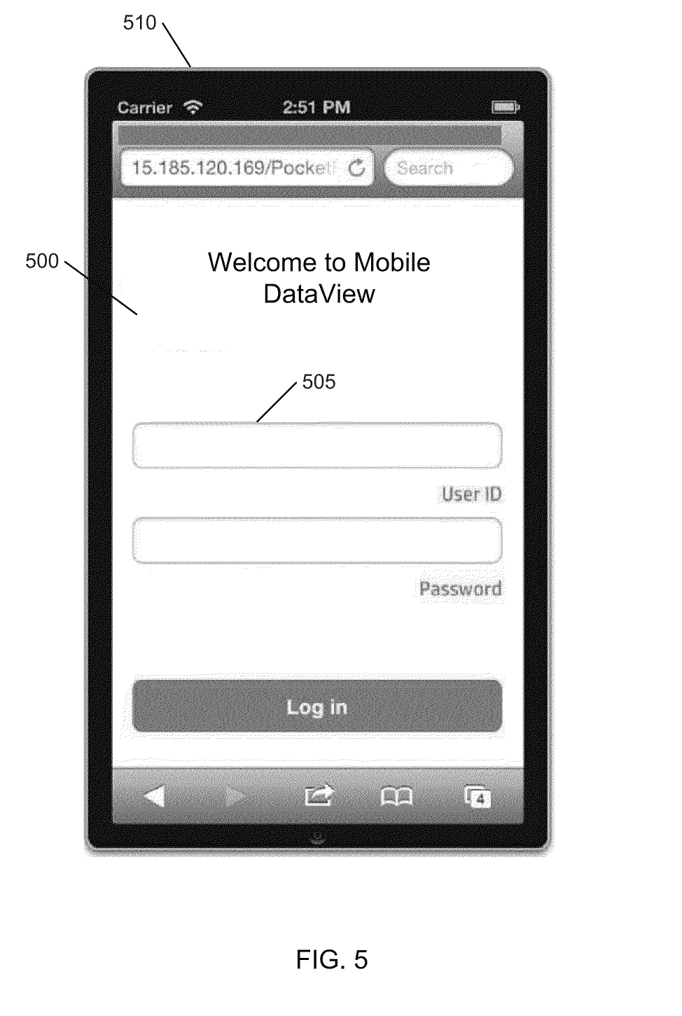

Referring now to FIGS. 4-18, various example display views generated, by the User interface Module 215 are described. Display screen 400 shows an initial loading screen that is displayed to a user of mobile device 405. The display screen 100 may show an infographic 410 to indicate that the display views generated by the User Interface Module 215 are being loaded for display to the user. It is to be noted that the display screen 400 may be accessed by the user by entering a web site address associated with the platform 200 in address bar 415 or via an application (not shown) deployed in mobile device 405. FIG. 5 shows that only registered users may access the platform 200. Display screen 500 illustrates a login window 505 for a user to enter login credentials granting access to platform 200. The login window 505 enforces a level of security and privacy to the numerical information that is to be displayed in the mobile device 510.

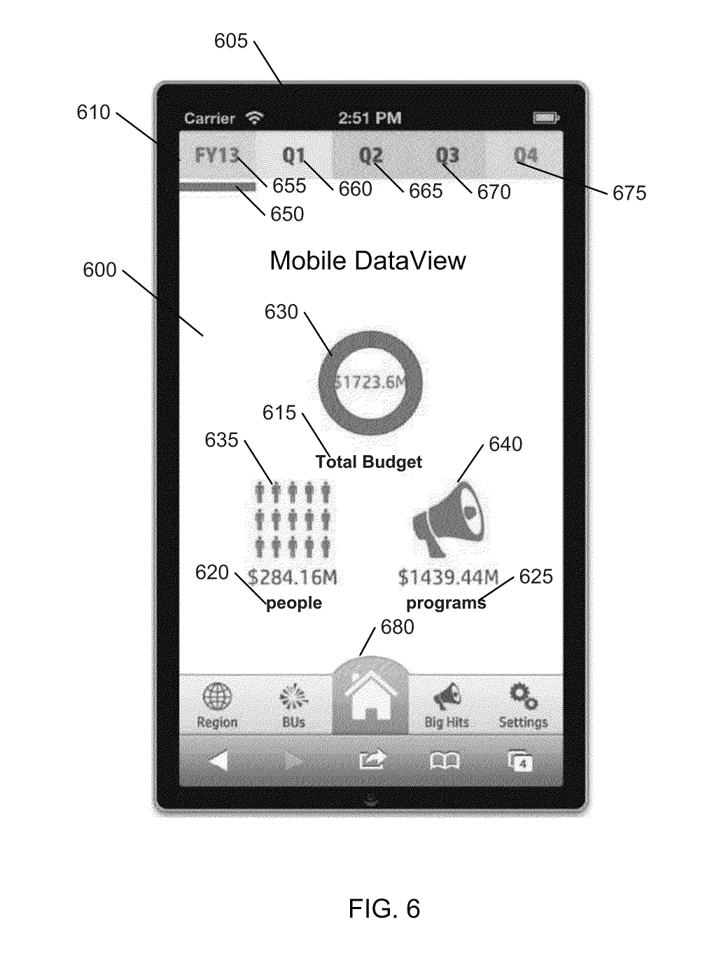

Attention is now directed to FIG. 6, which shows an example display view generated by the User Interface Module 215 of FIG. 2. Display view 600 enables a registered. user of platform 200 in mobile device 605 to have an easy to understand and informative visual representation of numerical data. At the top of display view 600 in window 610, users see different time periods during which data attributes can be aggregated and displayed in display view 600 with associated infographics. For example, the data attributes of “Total Budget” 615, “People” 620, and “Programs” 625 are displayed in display view 600 with associated infographics 630, 635, and 640. Each one of these infographics is selected to convey information to users, with people shown for HR expenditures, a bull horn shown for programs (Which shout out to users), and so on. The users can quickly glance at the display screen of mobile device 605 and know what the numbers below the infographics represent.

The time periods displayed in top window 610 can include a fiscal year (e.g., “FY13”) and quarters (e.g., “Q1”, “Q2”, “Q3”, and “Q4”), or any other time period desired. The values of data attributes 615-625 are shown aggregated for the time period of FY13 as indicated by the highlighted graphic 650 below the “FY13” label 655. For example, the value of the data attribute 615 indicates the total budget for FY13, the value of data attribute 620 indicates the total amount spent in people for FY13, and the value of data attribute 625 indicates the total amount spent in programs for FY13.

Each time period in top window 610 can be displayed in a different color to make it easier for the users to differentiate between different display views. The color of the time period label in top window 610 can match the color of the infographics and data attributes displayed for that time period. It is understood that any desired color scheme may be adopted for display screen 600. For example, label 655 and infographics 630-640 can be displayed in blue, label 660 can be displayed in green, label 665 can be displayed in pink, label 670 can be displayed in red, and label 675 can be displayed in orange.

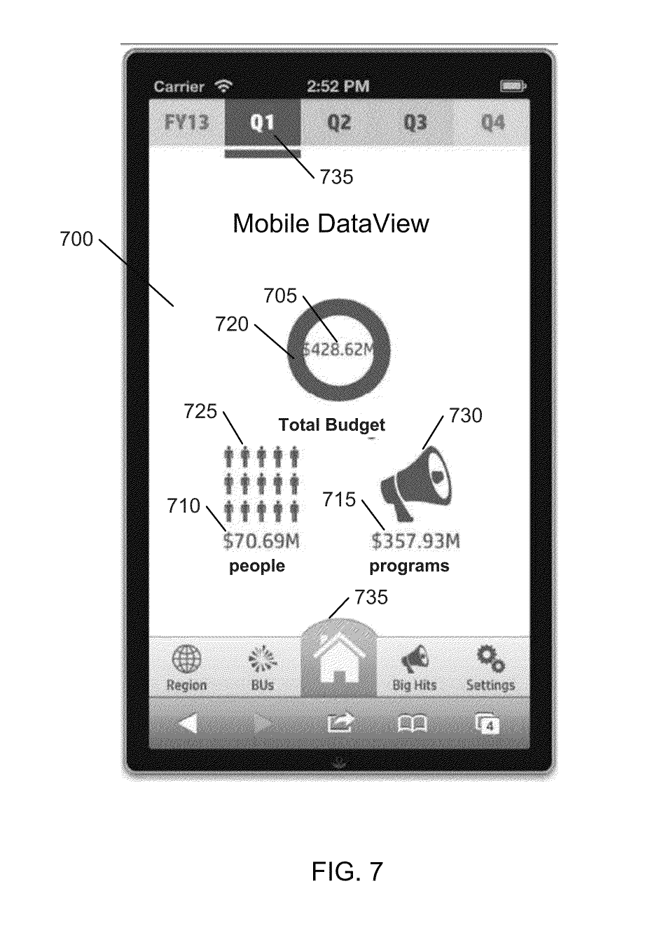

Users can click on any one of the time periods displayed in top window 610 to see the values of data attributes 615-625 for that given time period. FIG. 7 shows the same data attributes of “Total Budget”, “People” and “Programs” with values 705-715 aggregated for the first quarter “Q1” of FY13 in display view 700. In this case, the color of the infographics 720-730 associated with the data attributes' values 705-715 matches the color of label 660 in FIG, 6 and label 735 in FIG. 7.

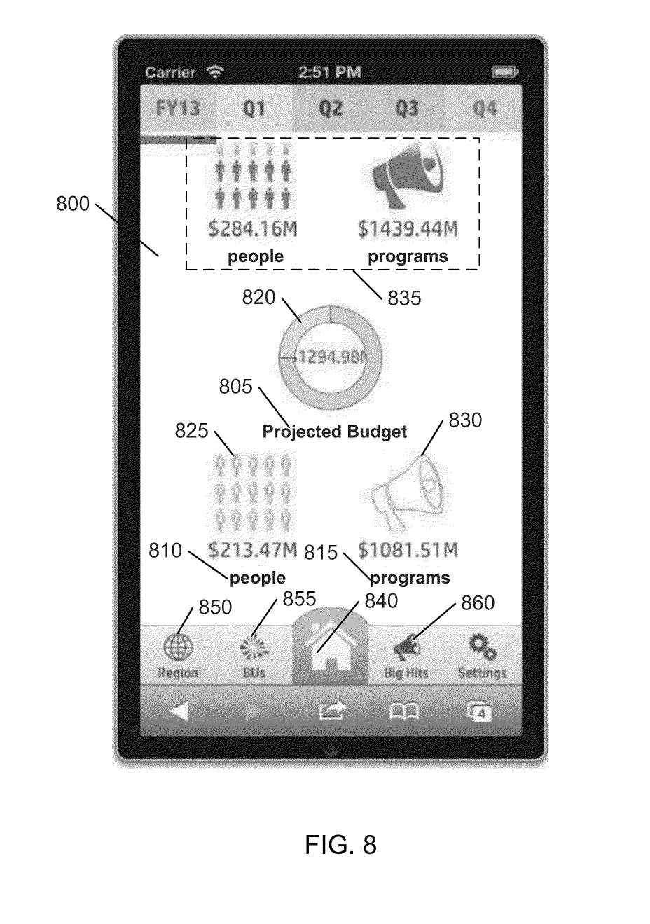

Attention is now directed to FIG. 8, which shows additional data attributes that can be displayed upon expanding (e.g., scrolling down) display view 600 of FIG. 6. Each display view generated by the User Interface Module 215 can be expandable to show additional data attributes. For example, display view 800 shows additional data attributes of “Projected Budget” 805, “Projected People” 810, and “Projected Programs” 815. These additional data attributes 805-815 are displayed with associated infographics 820-830 that are similar to infographics 630-640 of FIG. 6. Users can see data attributes 805-815 displayed in display view 800 by scrolling down the window of display view 600, such as, for example, by touching the screen of mobile device 605 to display the additional data. As shown in display view 800, part of display view 600 is still visible on top region 835.

The display view 600 is a display view that the user can revisit by clicking on home infographic 840 (also seen as infographic 680 in FIG. 6 and infographic 735 in FIG. 7), much like revisiting a home web page in a web browser. Next to the home infographic in window 845, the user has access to data displayed in other selected categories, such as, for example, the categories of “Region” 850, “Business Units” (or BUs) 855 and “Big Hits” 860. Clicking on any one of the selected categories 850-860 triggers the display of data attributes in the clicked category.

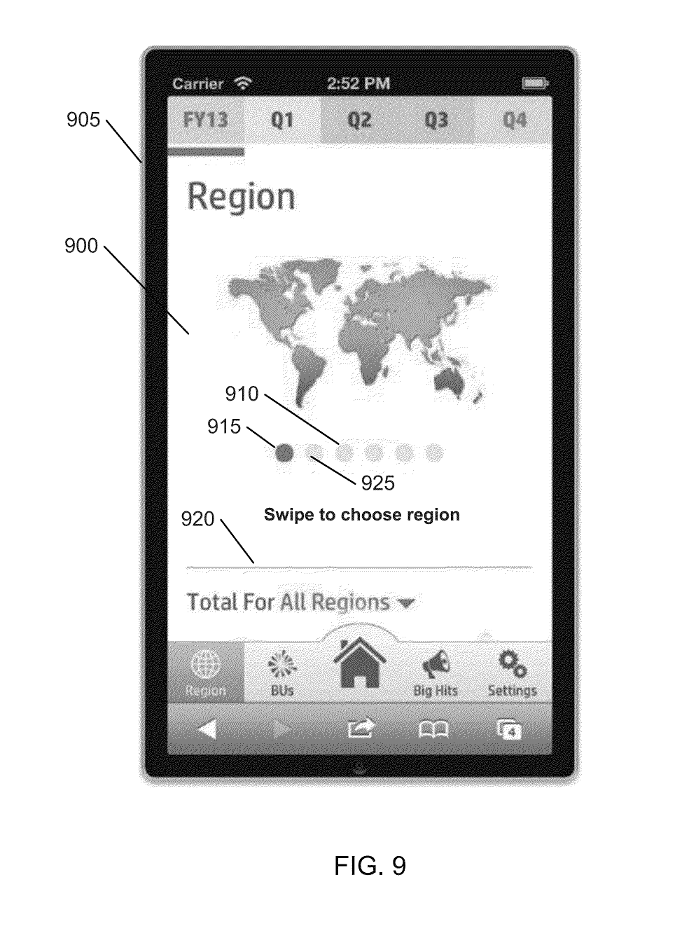

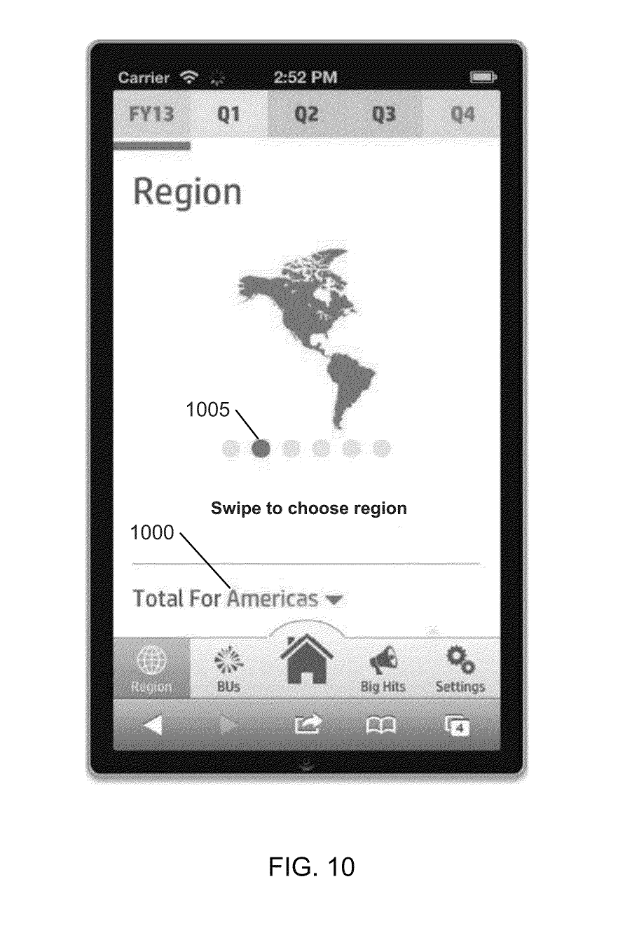

FIG. 9 shows an example display view of data attributes for the Region category 850. Upon clicking on the infographic associated with Region 850 in display view 800, users are shown display view 900 in FIG. 9. Users can swipe the display screen of mobile device 905 at infographic 910 to see values for data attributes for a selected region. For example, selecting circle 915 in infographic 910 allows users to see values for data attributes aggregated for all regions by scrolling down to area 920 of display view 900. Selecting circle 925 in infographic 910 allows users to see values for data attributes aggregated for the “Americas” region, Users can see the values by scrolling down to area 1000 in FIG. 10. Each time the user swipes to a different region, a graphic indication may be shown to indicate a new display view, such as, for example, highlighting the circles in infographic 910 with a different color when they are selected by the user (e.g., circle 1005 is highlighted in FIG. 10 to display the values for the region “Americas”).

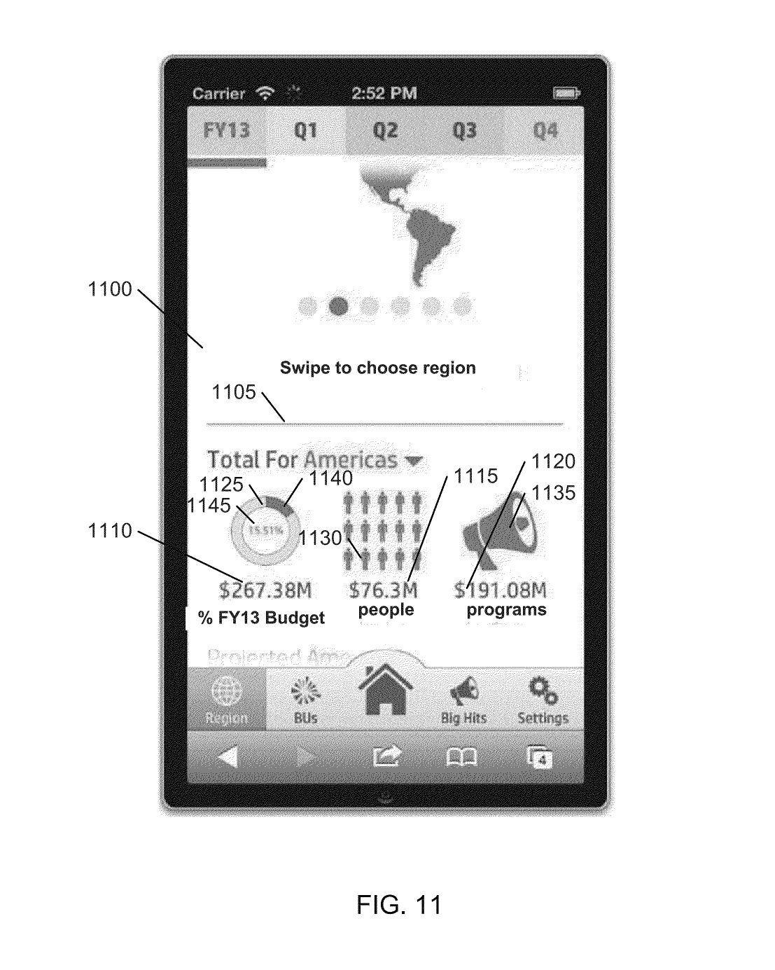

FIG. 11 shows a display view 1100 that comes up when the user scrolls down to area 1000 in FIG. 10. Users are able to see values of data attributes aggregated for the selected region “Americas”, including, for example, a total budget 1110 for the region, a total value 1115 spent on people for the region, and a total value 1120 spent on programs for the region. Each data attribute displayed for the selected region category is shown with an associated infographic to facilitate the user's grasp of the data. For example, total budget 1110 is shown with infographic 1125, total value 1115 spent on people is shown with infographic 1130, and total value 1120 spent on programs is shown with infographic 1135. It is noted that infographic 1125 has a portion 1140 highlighted to indicate a percentage value, which in this case, is a percentage of the budget spent in the selected region relative to the total budget spent for the fiscal year. Using a donut-shaped infographic 1125 allows reuse of space (inside the circle 1145) in addition to under it and provides an efficient and elegant visualization of data.

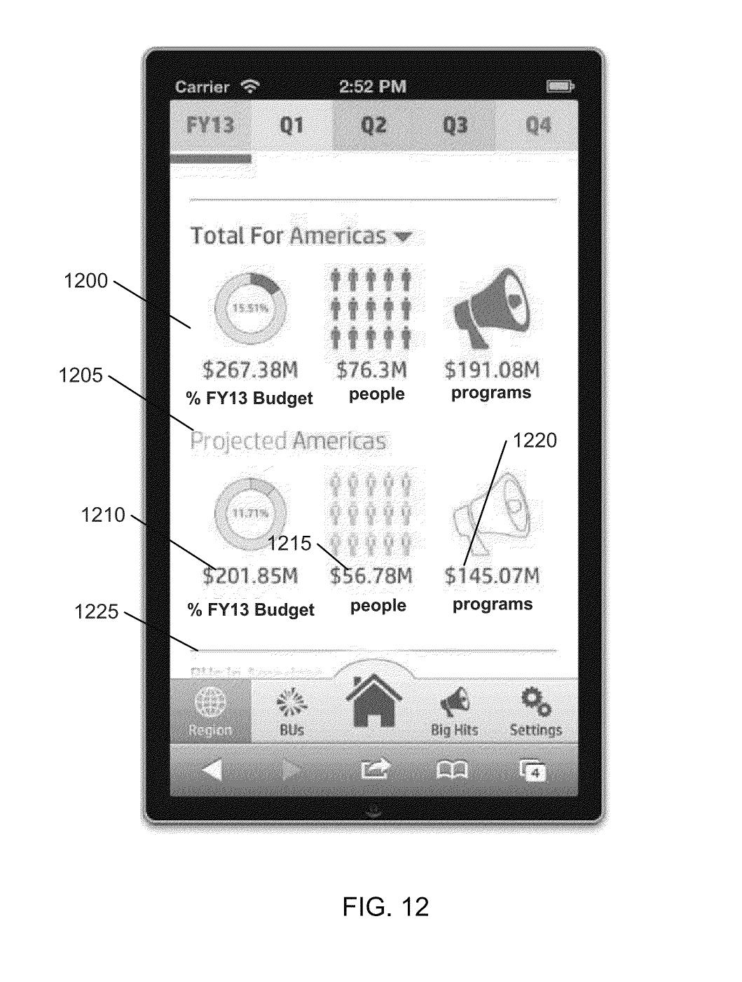

Further scrolling down display view 1100 enables users to see additional data for the selected, region. For example, FIG. 12 shows a display view 1200 with projected values for data attributes 1210-1220. Notice that data attributes 1210-1220 are projected values of data attributes 1110-1120. By showing both total and projected values for the selected region in the same display view 1200, users can quickly glance at the visual information and learn about their data much more efficiently than if they were trying to access their data in a spreadsheet or another form.

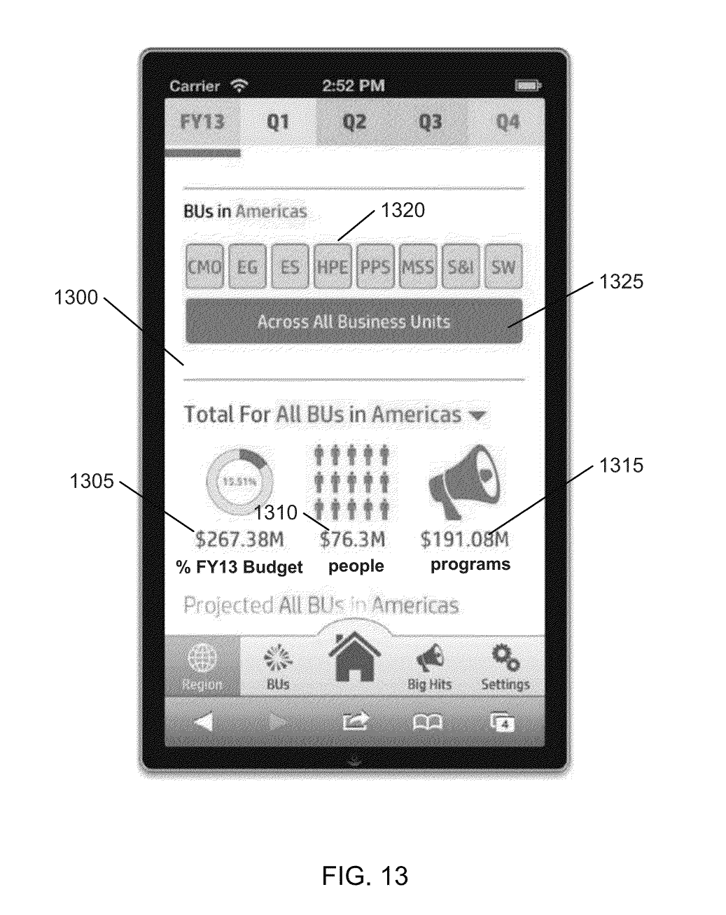

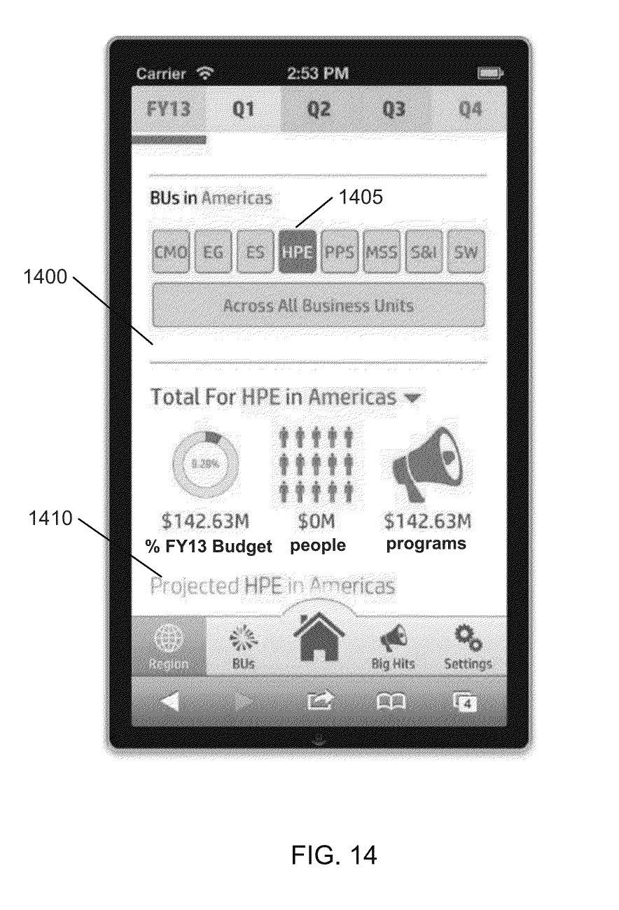

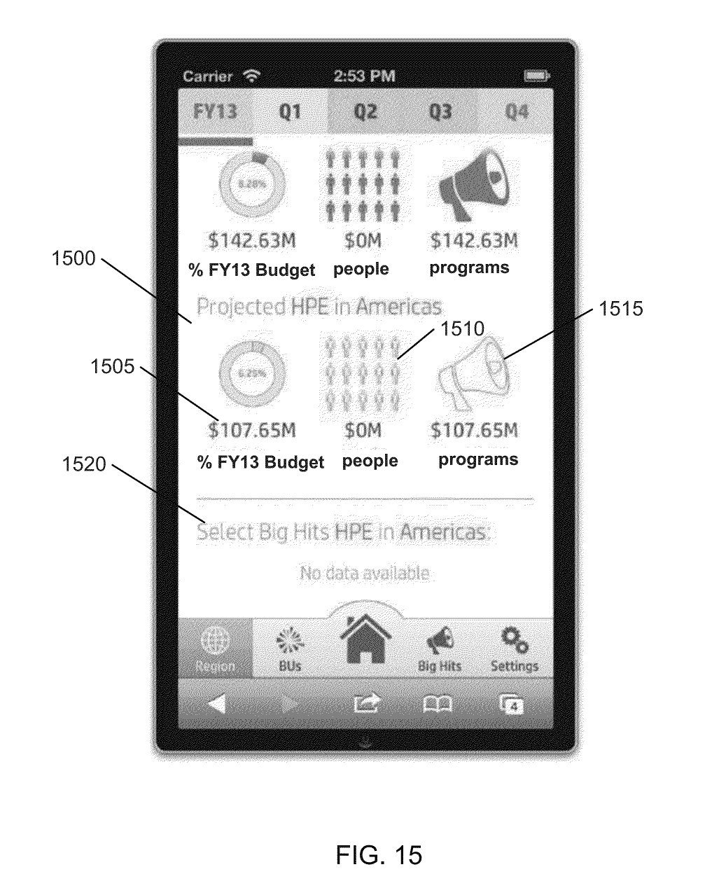

The users can also continue to scroll down the display view 1200 to see additional data for the selected region “Americas”. For example, scrolling down to region 1225 enables users to see data attributes displayed across different selected categories. FIG. 13 shows an example display view that may be shown to users scrolling down display view 1200. Display view 1300 shows the data attributes 1305-1315 across the category of “Business Units” for the region “Americas”. At the top of display view 1300, users are shown an infographic 1320 where they can select different business units for display. The display view 1300 is showing the data attributes 1305-1315 across all business units indicated in infographic 1320 with highlighted box 1325. Clicking on another box to show data for a given business unit has the effect of highlighting the clicked box and showing data attributes for the selected business unit. For example, FIG. 14 shows a display view 1400 that displays data attributes for the business unit “HPE” selected by the user when clicking on box 1405, which is now highlighted. Scrolling down display view 1400 enables the user to see additional data attributes in display view 1500 of FIG. 15, such as a projected budget 1505, a projected value spent on people 1510, and a projected value spent on programs 1515, all for the business unit “HPE” in the region “Americas”.

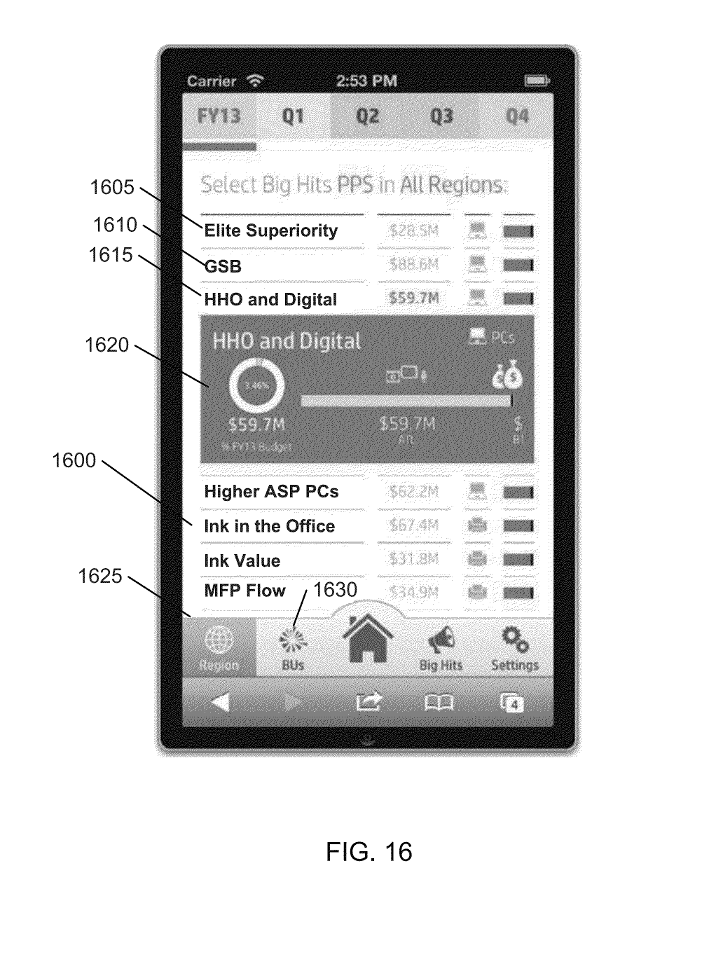

Scrolling further down display view 1500 to region 1520 enables the user to see yet additional data attributes, this time displayed for a different category of “Big Hits” across the business unit “HPE” in the region “Americas”. An example display view that may be displayed when scrolling down to region 1520 is shown in FIG. 16. Display view 1600 presents data attributes for the category of “Bit Hits” across the business unit “PPS” in all geographical regions. Notice that the data attributes shown in display view 1600 are different than the data attributes displayed before for other categories. For example, display view 1600 shows total budget values for different marketing programs, such as “Elite Superiority” program 1605, “GSB” program 1610, and “HHO and Digital” program 1615, among others. Users can click on any one of the displayed programs to see additional data, such as the data displayed in window 1620 for the selected “HHO and Digital” program 1615.

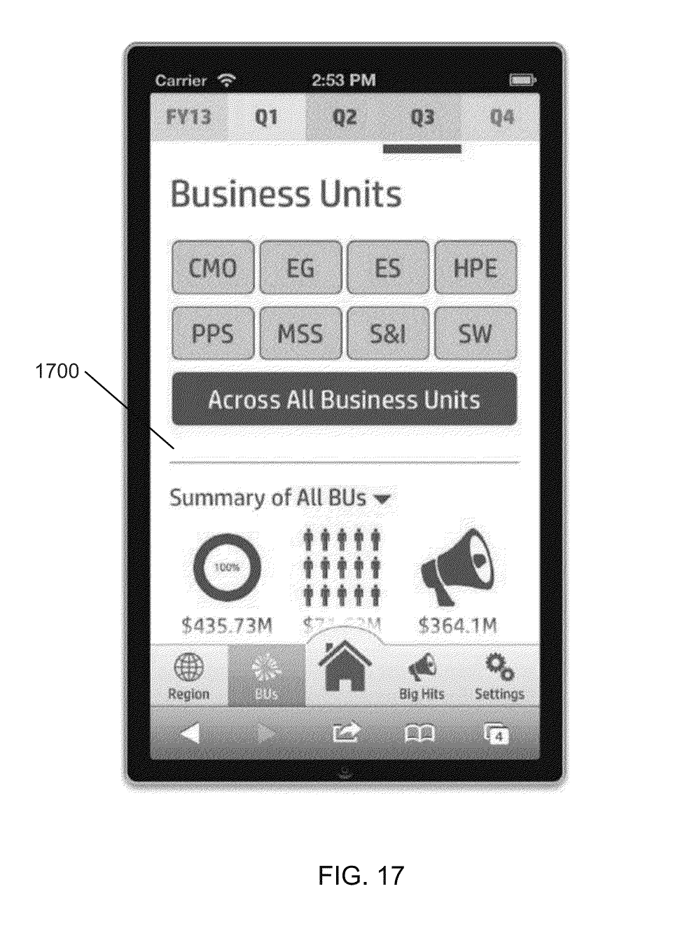

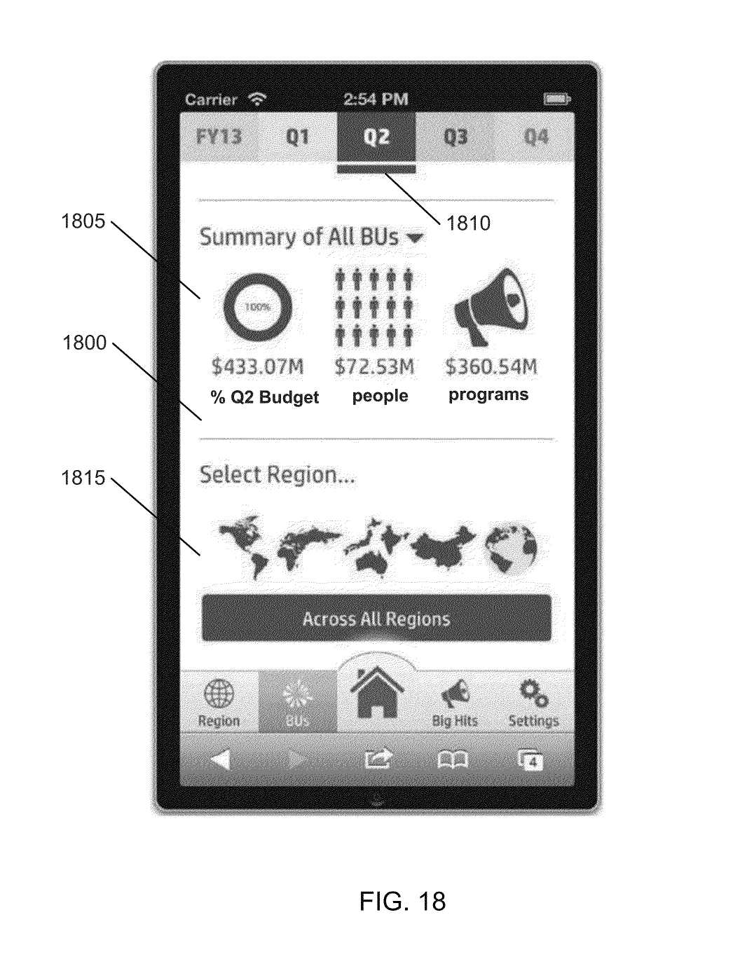

Users can also select a different category at any time by clicking on a infographic associated with the category at the bottom of a display view, such as, for example, at window 1625 at the bottom of display view 1600. FIG. 17 shows a display view 1700 that is displayed when a user clicks on the “BUs” infographic 1630 at window 1625 of display view 1600. Again, users are able to see a visual display of numerical data that spans multiple categories (e.g., across different time periods and geographical regions). Scrolling down a display view enables the users to see additional data, as shown, for example, in display view 1800 of FIG. 18 with data attributes 1805 for all “BUs” in the Q2 time period 1810 and across all regions 1815.

Users can interact with the display views to get a view of the numerical data that is much more efficient and visually appealing than a standard spreadsheet or other document. The display views are available at the users' fingertips with a mobile device. Users can instantly see numerical data with visually appealing graphics in a small mobile device screen without having to wait to open up a spreadsheet in a large display to view the desired data. In addition, users can have individualized display views that are customized for their needs and desires. A given user in an organization may see the same data as another user, but with individualized display views that reflect the given user's needs and desires through abstraction in infographics. While the numerical data may be shared by multiple users, each user may see the data with the same or different display views according to their needs.

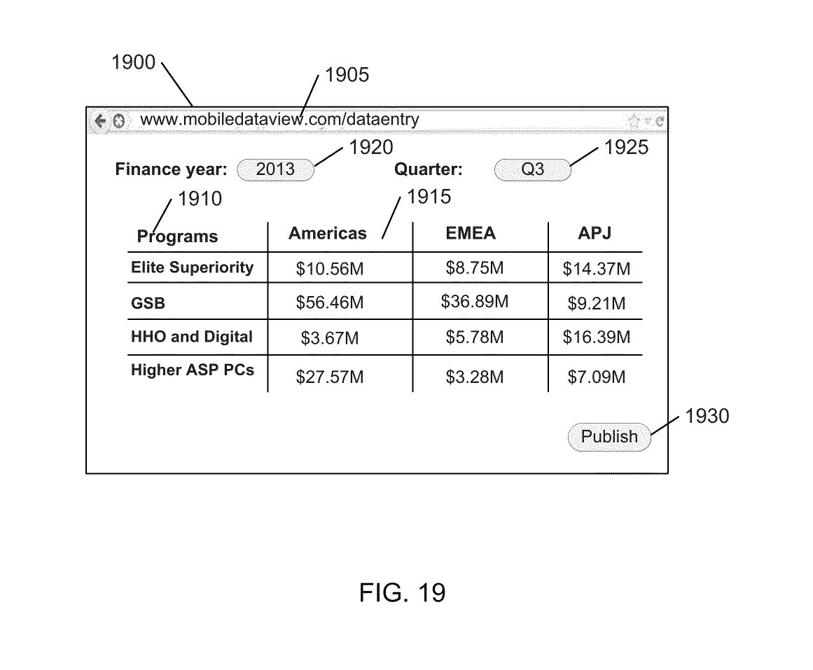

As described above, the numerical data that is displayed in display views generated by the User interface Module 215 shown in FIGS. 2-18 can be received via a live stream captured by the Data Retrieval Module 205, sent by a user to the Data Retrieval Module 205, or entered by a user in a customized user interface connected to the Data Retrieval Module 205. FIG. 19 shows an example customized user interface that may be used to enter numerical data for display in a mobile device. User interface 1900 may be a web based user interface accessible via a URL address 1905. Users may enter data for multiple categories, such as, for example, data for different marketing programs 1910 across different regions 1915 and time periods 1920-1925. When the user is done entering data, the user can click on the button “Publish” 1930 to publish the data to the display views generated by the User Interface Module 215.

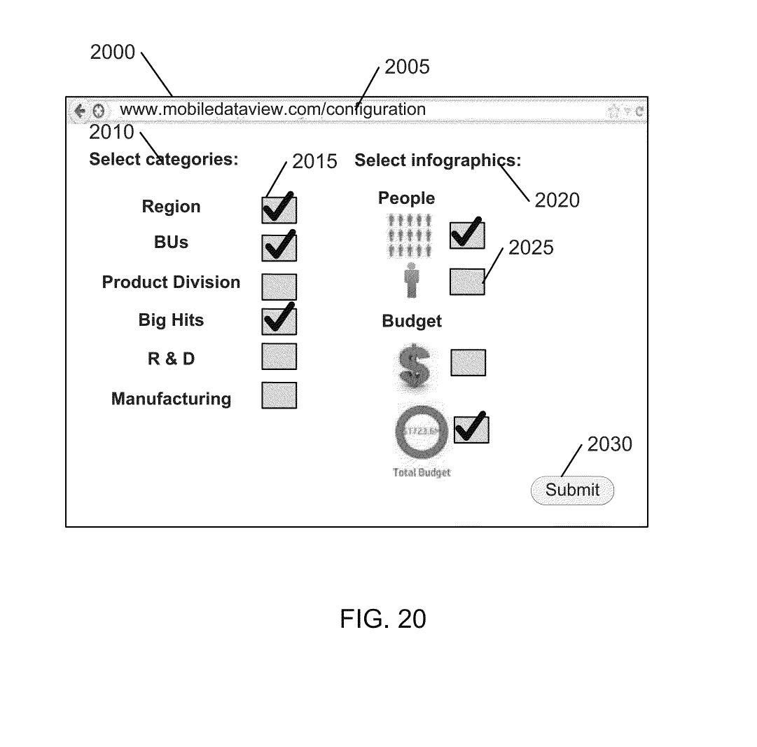

In addition to entering data in a customized user interface, users can also select the categories and infographics desired for display using Configuration Module 210 shown in FIG. 2. An example configuration screen generated by Configuration Module 210 is shown in FIG. 20. Configuration screen 2000 may be a web based user interface accessible via a URL address 2005. Users may select categories 2010 by clicking on boxes 2015 and select infographics 2020 by clicking on boxes 2025. When the user is done with the selections, the user can click on the button “Submit” 2030 to notify the User Interface Module 215 that the display views can be generated. Now it is to be noted that the categories and infographics shown in FIG. 20 are shown for illustration purposes only. Different and/or additional categories and infographics may be shown by the Configuration Module 210. The categories and infographics can also be selected ahead of time by various decision makers in an organization deploying platform 200 in FIG. 2 to visualize numerical data. The platform 200 described herein enables users to have a visually appealing and informative view of numerical data in a mobile device screen, without having to deal with often large and cumbersome spreadsheets.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A computer implemented method for representing numerical data in a mobile device, the method comprising:
receiving numerical data from at least one party, the numerical data arranged into multiple categories;
selecting categories from the multiple categories for display in a mobile device;
associating, by a computer, data attributes in each selected category with at least one infographic; and
creating, by a computer, display views of the data attributes in each selected category using the at least one infographic, the display views expandable for each selected category.

2. The computer implemented method of claim 1, wherein receiving numerical data from at least one party comprises receiving numerical data entered by the at least one party in a customized user interface.

3. The computer implemented method of claim 1, wherein receiving numerical data from at least one party comprises receiving a live stream of numerical data for processing at the computer.

4. The computer implemented method of claim 1, comprising receiving updates on the numerical data.

5. The computer implemented method of claim 1, comprising aggregating data attributes in each selected category across at least one of: time, geographical region, and a dimension of interest.

6. The computer implemented method of claim 1, comprising transmitting the display views for display at a mobile device accessible to login users.

7. The computer implemented method of claim 6, wherein the display views are expandable for each selected category upon interaction of a login user with the display views at the mobile device.

8. The computer implemented method of claim 7, in the display views are customized for each user of the mobile device.

9. The computer implemented method of claim 1, wherein creating the display views comprises using different colors for the display views across at least one of time and geographical region.

10. A system for representing numerical data in mobile device, comprising:
a processor; and
a set of memory resources storing a set of modules with routines executable by the processor, the set of modules comprising:
a data retrieval module to receive numerical data from at least one party, the numerical data arranged into multiple categories;
a configuration module to select data categories and a plurality of infographics for the data categories; and
a user interface module to create display views of numerical data in the selected data cateigories using the plurality of infographics, the display views expandable for each selected data category.

11. The system of claim 10, wherein the data retrieval module comprises a customized user interface accessible by the at least one party to enter the numerical data in one or more user interface screens.

12. The system of claim 10, wherein the data retrieval module comprises routines to receive a live stream of the numerical data.

13. The system of claim 10, comprising a data processing module to process the numerical data and extract values for a plurality of data attributes.

14. The system of claim 10, wherein the configuration module comprises a configuration user interface accessible by the at least one party.

15. The system of claim 10, comprising a data publishing module to publish the display views to a web client accessible by a login user at the mobile device.

16. The system of claim 15, wherein the data publishing module receives requests for display views from the login user at the mobile device.

17. The system of claim 16, wherein the requests are received upon interaction of the login user with the display views at the mobile device.

18. A non-transitory computer readable medium comprising instructions executable by a processor to:
identify selected categories from multiple categories of numerical data;
identify data attributes within the selected categories;
aggregate the data attributes within the selected categories across time and geographical regions;
associate each data attribute with an infographic; and
display values for the aggregated data attributes with associated infographics in a plurality of display views, the display views expandable for each selected category.

19. The non-transitory computer readable medium of claim 18, wherein to display values for the aggregated data attributes with associated infographics in a plurality of display views comprises to transmit the display views to a mobile device accessible by a login user.

20. The non-transitory computer readable medium of claim 19, further comprising to receive requests for expandable display views from the login user upon interaction of the login user with the display views at the mobile device.
